(19) United States
(12) Patent Application Publication
(10) Pub. No.: US 2009/0327082 A1
(43) Pub. Date: Dec. 31, 2009

(54) METHOD AND SYSTEM FOR PROVIDING A VOICE E-MAIL MESSAGING SERVICE

(75) Inventors: Warner Johnson, Clavarack, NY (US); Guibert Englebienne, Buenos Aires (AR)

Correspondence Address: DARBY & DARBY P.C., P.O. BOX 770, Church Street Station, New York, NY, 10008-0770, US

(73) Assignee: 2SPEAK, INC., New York, NY (US)

(21) Appl. No.: 12/553,730

(22) Filed: Sep. 3, 2009

Related U.S. Application Data
(63) Continuation of application No. 11/158,343, filed on Jun. 20, 2005.
(60) Provisional application No. 60/580,960, filed on Jun. 18, 2004.

(51) Int. Cl. G06Q 40/00; G06F 15/16; G06Q 30/00; G06F 3/048

(52) U.S. Cl. 705/14.66; 709/206; 705/34; 715/752; 709/247; 705/40; 705/14.4

(57) ABSTRACT

A method of transmitting a multimedia file over a network includes receiving, from a user, a user contact and a recipient address which can be received though at least one of a SMS message, an e-mail message, an Internet form or an HTTP protocol message. The user inputs the information and transmits it to the system. Once the information is received, the system contacts the user at the user contact and the user is prompted to record a message. The message is recorded as a multimedia file and, once recorded, the system transmits the multimedia file to the recipient address. The system can send an e-mail to the recipient address attaching the multimedia file, provide a link to download or stream the multimedia file, provide a callback telephone number to play the multimedia file over a telephone, and send the multimedia file to a cellular telephone as a message.

### BACKGROUND OF THE INVENTION

1. Field of the Invention

The invention relates to a method and system to deliver multimedia files, previously recorded, to numerous users via e-mail.

2. Discussion of the Related Art

Both e-mail and voice mail systems are known in the art. E-mail and voice mail systems are typically separate and distinct systems. A user receives an e-mail on his or her e-mail system, the user typically replies with an e-mail. Similarly, when a user receives a voice mail message, the user typically responds by telephone communication. Further, both systems have their strengths and drawbacks.

E-mail has the advantage of allowing a sender to communicate the same message to numerous recipients essentially simultaneously. List the e-mail addresses of the recipients, include the “carbon copies” and the “blind carbon copies”, and press send, and exact copies of the sender's message are received by every listed recipient. Thus, if the sender wishes to communicate with 20 different recipients, the sender need only compose and send one e-mail and all 20 recipients will receive it. Additionally, e-mail provides an electronic copy of the message, both in the sender's and recipient's e-mail system and the e-mail can be printed to provide a physical copy of the message. Further, a “return receipt” can be requested to verify that a recipient receives and opens the message. One drawback to e-mail messages is the time it takes for the sender to compose the e-mail. Most senders do not have moderate to advanced typing skills and composing an e-mail is time consuming to type and correct. Alternately, a sender can draft a hard copy or dictate an e-mail and have another person transcribe the draft into the e-mail message to be transmitted. The above are very time consuming and labor intensive procedures.

Voice mail has different advantages and disadvantages. Most senders can speak faster than they can type so a 1 minute voice message may save a user 20 minutes drafting an e-mail. Also, a voice message is more personal than an e-mail in that the tone of the sender's voice can also convey information. However, voice mail is limited in that only one message can be left per recipient. Thus, if the sender desires sending the voice mail to 20 recipients, the sender must make 20 telephone calls and leave 20 messages. This is very time consuming and allows for a chance that the sender will miscommunicate one of the 20 messages. Additionally, voice mail messages are rarely saved and thus no record of the message is preserved. Preserving a record of a voice mail typically requires the sender/recipient to transcribe the voice mail. This is a time consuming and labor intensive process.

Thus, there is a need in the art for a system that incorporates the speed and personal nature of voice mail with the ability to preserve a copy of the message along with the ability to communicate with multiple recipients essentially simultaneously.

### SUMMARY OF INVENTION

A method of transmitting a multimedia file over a network includes receiving, from a user, a user contact and a recipient address which can be received though at least one of a SMS message, an e-mail message, an Internet form or an HTTP protocol message. The user inputs the information and transmits it to the system. Once the information is received, the system contacts the user at the user contact and the user is prompted to record a message. The message is recorded as a multimedia file and then the system transmits the multimedia file to the recipient address. The system can send an e-mail to the recipient address attaching the multimedia file, provide a link to download or stream the multimedia file, provide a callback telephone number to play the multimedia file over a telephone, and send the multimedia file to a cellular telephone as a message.

In one embodiment, the user contact is a telephone number the user can be reached at once the information is received by the system. In another embodiment, a user enters a website hosting the system and is prompted for information. The user then fills out an information form with all required and additional information. Additional information requested by the system can be the user's name, e-mail address, billing information, login password and numerous other options, some of which are described below. In one embodiment, the system needs the telephone number where the user can be reached and the listing of addresses to send the multimedia file. The user inputs the information and transmits it to the system. The system can also accept information from any device that can transmit an HTTP protocol. Devices include a desktop computer, a handheld computer, PDA, and a web enabled cellular telephone (e.g. WAP capable).

Once the information is received the system, the system contacts the user at the user contact, for example, at a telephone number provided. One embodiment sends the telephone information to a software enabled telephone switch which enters the number and initiates the call as a voice over IP call, a.k.a. an Internet phone call. Thus, the first leg of the telephone call is initiated over the Internet and standard long distance telephone rates do not apply. Once the telephone call reaches the local area where the user is residing, the call enters the local telephone network and the call is connected to the user. Currently both voice only and video and voice telephones are available and the invention contemplates the use of either or both types of telephones. The user can be prompted to input the type of telephone he can record the message on.

The user is then prompted to record a message and, as part of the prompt, the system can provide a menu to the user. The menu can be as simple as confirming the person on the telephone is the user and as complex as to offer additional options both before and after the user records the message. In an embodiment, the message is recorded as a multimedia file, a .WAV file for audio or an .AVI file for audio and video. Additional options can include billing options, if the user desires to replay or rerecord the message, or if the user wants to record a second message to the same or different recipient address.

Once the message is recorded as a multimedia file, the system transmits the multimedia file to the recipient address. The file can be transmitted in numerous ways. In an embodiment, the multimedia file is attached to or downloaded from a link embedded in an e-mail. Thus, there is an electronic copy of the electronic message that can be stored by the recipient. Another embodiment also sends a copy of the multimedia file to the user for the user's records.

An embodiment streams the multimedia file to the recipient. Further, if a recipient does not have speakers attached to the computer, is in a public location, or is unable to receive or open the multimedia file, the recipient can be provided a telephone number where the recipient can call in and hear the message. Similarly, the multimedia file can be transmitted to a cellular telephone as a message and listened to by the recipient.

The invention can be used to not only record short messages, but it is contemplated that the system can record long meetings, for example, while on a speaker phone. Additionally, .WAV files can be very large with a short recording time. An additional embodiment compresses the multimedia file prior to transmitting the file. Any compression standard can be used, including the global system mobile (GSM) compression algorithms and MP3 compression algorithms. One embodiment utilizes the GSM compression because it is common to both Windows and Macintosh based computing platforms.

When a compression algorithm is used, an embodiment can save both the uncompressed multimedia file and the compressed multimedia file as separate files while transmitting the compressed multimedia file to the recipient. However, because some recipients may not have the proper decompression software, the system can provide a link to the uncompressed multimedia file and the recipient can then access the uncompressed multimedia file. Thus, a user is guaranteed that all recipients can access the message.

Either or both the compressed or uncompressed multimedia files can be saved locally by the user and recipient or by the system. The system can delete the messages after a specified amount of time, or the system can offer data storage services for a fee.

A further embodiment includes converting the multimedia file to a text file and transmitting the text file to the recipient address. The system can provide speech to text conversion where the multimedia file is electronically transcribed and the text of the message is sent to the recipient. This provides either the user or the recipient the ability to have a hard copy of the message for a paper file.

Numerous embodiments are contemplated for billing the user for the service. One billing method includes tracking either a usage number based on a number of times the user records a message or a time number based on a length of time of each recorded message. Once either the usage or time number is determined, the user is charged based on the number times a price. A fixed price can be used, for example, $1.00 per message or $0.25 per recorded minute. Alternately, volume discounts can be offered, for example, $1.00 for the first 5 messages and $0.50 for all additional messages. Either tracking method can be used depending on the system or user's choice. Additionally, the user can prepay for the service at the beginning of the billing cycle and the system can include deducting the charge from the prepaid account. Further, the system can charge a flat monthly fee instead of or in addition to the above mentioned fee. One embodiment of the monthly fee is a somewhat large one time fee for unlimited use. Another embodiment is a small fee in addition to tracked options to provide a minimum amount to complete electronic transactions with, for example, banks and credit card companies.

Advertising can also be used either to increase revenues or to permit the user to access the system free of charge. The method includes attaching an advertising multimedia file to a beginning of the multimedia file prior to transmitting the file. An advertising multimedia file is created and this can be akin to a radio or a television commercial and is appended to the beginning of a message multimedia file so the recipient is compelled to listen to the advertising portion prior to listening to the message.

Further, for the e-mail transmission embodiments, the method can include an advertising banner in the e-mail. Either the advertising multimedia file or the advertising banner can also be interactive and provide links to the advertisers, for example, via hyperlink, e-mail and telephone. Thus, an interested user can request more information regarding the advertised product. Furthermore, for the telephone transmission embodiments, prompts can be provided to allow the recipient to choose the product or information from the list of menu options.

Other embodiment account for if a user is a member of a community, typically an on-line community or logs into the system through a specifically themed website hosting the system. Once the user's information is received, the system can identify the community associated with the user and determine one or both of the advertising multimedia file and the advertising banner associated with the community. Once the advertising is determined, either the associated advertising multimedia file is attached to the multimedia file, or the associated advertising banner is included in the e-mail to the recipient (step 408). This embodiment allows advertisers to target users and recipients with particular interests. For example, MTV.com can host the system and a user can access the system through MTV.com. The system identifies that the user is associated with MTV.com and searches for music related advertising. Once the appropriate advertising is found, the multimedia file or banner is provided to the recipient as above.

Other embodiments are for billing and crediting a community when a user is a member of the community. The method includes identifying the community associated with the user and tracking at least one of the usage number and/or the time number. The user is then billed a charge based on one of the usage number or the time number multiplied by the corresponding price. Typically, if the user is accessing the system through a community, the community is entitled to a portion of the charge and the community is paid a portion of the charge.

Another embodiment of the invention allows the user to access the system through a voice menu system. First, the user can configure an account by providing one or more of, billing information, contact information, and one or more recipient addresses. The account can be configured so that recipients can be grouped and placed under a number, for example, all family contacts can be number “1”. Once the account is configured, the user can be provided with a system access telephone number. The user can call in and identify a recipient address, i.e. number 1 in a menu system to select family contacts, record a message and the invention can operate as above. This allows a user to send an e-mail by using any telephone and does not require an Internet or network connection.

Further embodiments permit the user's entire contact list to be accessed through the voice menu system and using speech recognition to determine a recipient. For example, a user can be prompted, while configuring the account, to provide audio tags for a specific number of contacts. For example, the address of the user's wife can be stored with the audio tag “wife”. Then, when the user calls in, he can say “wife” to select the recipient as the wife's address, the user records the message and embodiment functions as above. Other voice menu prompts can be associated with other recipients or groups of recipients.

Another embodiment is a method where the system contacts the user by opening a multimedia recording session on the user's computer. Either the system can identify the computer's hardware and software capabilities or that information can be provided by the user. For example, the computer can be equipped with a microphone and web camera. Once the system contacts the user the system can open a multimedia session and the user can record the message at his computer. The multimedia recording session can be initiated on the user's own computer, the user can be directed to another web page, or the system can send the user an e-mail with a link to the recording page. Once the message is recorded, the inventor can function as described above.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is flow chart illustrating a method of transmitting a multimedia file over a network according to the present invention;

FIG. 2 is a flow chart illustrating a compression embodiment of the present invention;

FIG. 3 is a flow chart illustrating another embodiment of the present invention;

FIG. 4 is a flow chart illustrating a billing embodiment of the present invention;

FIG. 5 is a flow chart illustrating an advertising embodiment of the present invention;

FIG. 6 is a flow chart illustrating a community advertising embodiment of the present invention;

FIG. 7 is a flow chart illustrating a billing for a community embodiment of the present invention; and

FIG. 8 is a flow chart illustrating a voice over IP embodiment of the present invention.

### DETAILED DESCRIPTION OF THE PREFERRED EMBODIMENT

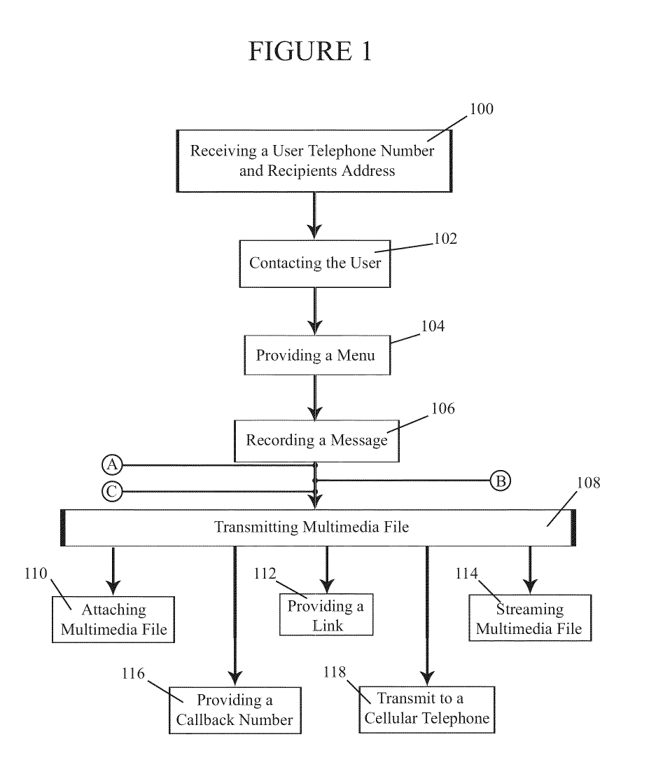

Referring to FIG. 1, a method of transmitting a multimedia file over a network is illustrated. The method includes receiving, from a user, a user contact and a recipient address (step 100). In one embodiment, the user contact is a telephone number the user can be reached at once the information is received by the system. The user contact and the recipient address can be received though at least one of a short message service message (SMS message), an e-mail message, an Internet form or an HTTP protocol message. In one embodiment, a user enters a website hosting the system and is prompted for information. The user then fills out an information form with all required and additional information. Additional information requested by the system can be the user's name, e-mail address, billing information, login password and numerous other options, some of which are described below. In one embodiment, the system needs the telephone number where the user can be reached and the listing of addresses to send the multimedia file. The user inputs the information and transmits it to the system. The system can also accept information from any device that can transmit an HTTP protocol. Devices include a desktop computer, a handheld computer, PDA, and a web enabled cellular telephone (e.g. WAP capable).

Once the information is received by the system, the system contacts the user at the user contact, for example, at a telephone number provided (step 102). One embodiment sends the telephone information to a software enabled telephone switch which enters the number and initiates the call as a voice over IP call, a.k.a. an Internet phone call. Thus, the first leg of the telephone call is initiated over the Internet and standard long distance telephone rates do not apply. Once the telephone call reaches the local area where the user is residing, the call enters the local telephone network and the call is connected to the user. In this embodiment, the system can call anywhere in the world and is only charged the local telephone charge once the call enters the local telephone network. Currently both voice only and video and voice telephones are available and the invention contemplates the use of either or both types of telephones. The user can be prompted to input the type of telephone he can record the message on.

The user is then prompted to record a message and, as part of the prompt, the system can provide a menu to the user (step 104). The menu can be as simple as confirming the person on the telephone is the user and as complex as to offer additional options both before and after the user records the message. The message is recorded as a multimedia file (step 106). In one embodiment, the multimedia file is a .WAV file for audio or an .AVI file for audio and video. Some additional options can include billing options, if the user desires to replay or rerecord the message, or if the user wants to record a second message to the same or different recipient address.

Once the message is recorded as a multimedia file, the system transmits the multimedia file to the recipient address (step 108). The file can be transmitted in numerous ways. The system can send an e-mail to the recipient address attaching the multimedia file (step 110), provide a link to download the multimedia file (step 112), or to stream the multimedia file (step 114), provide a callback telephone number to play the multimedia file over a telephone (step 116), and send the multimedia file to a cellular telephone as a message (step 118). A multimedia message format such as MMS or any other format has the ability to send messages comprising a combination of text, sounds, images and video to capable handsets. As long as the recipient has speakers attached to his or her computer, the recipient can hear the multimedia file.

In the embodiment where the multimedia file is attached or downloaded, there is an electronic copy of the electronic message that can be stored by the recipient. Another embodiment also sends a copy of the multimedia file to the user for the user's records.

The streaming embodiment allows recipients with slow Internet connections to have the multimedia file played without waiting for the entire multimedia file to download. Further, if a recipient does not have speakers attached to the computer, is in a public location, or is unable to receive or open the multimedia file, the recipient can be provided a telephone number where the recipient can call in and hear the message. Similarly, the multimedia file can be transmitted to a cellular telephone as a message and listened to by the recipient.

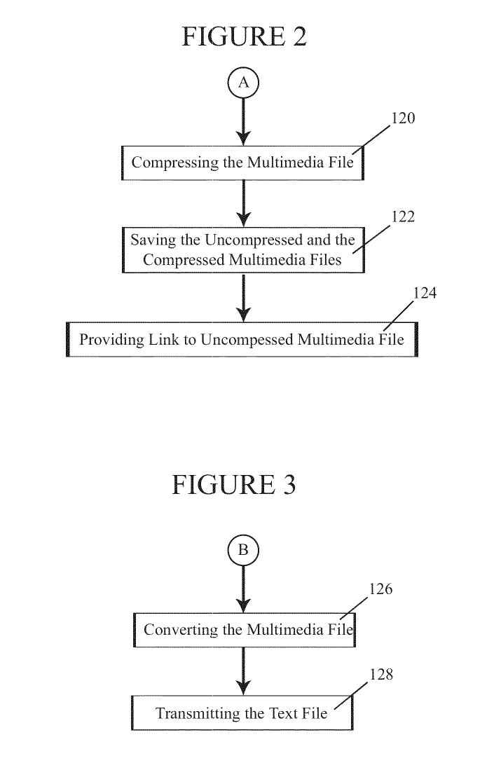

The invention can be used to not only record short messages, but it is contemplated that the system can record long meetings, for example, while on a speaker phone. Additionally, .WAV files can be very large with a short recording time. FIG. 2 illustrates an additional embodiment of compressing the multimedia file prior to transmitting the file (step 120). Any compression standard can be used, including the global system mobile (GSM) compression algorithms and MP3 compression algorithms. One embodiment selects the algorithm based on the level of compression and another embodiment selects the algorithm based on how many recipients are likely to have the means to decompress/read the multimedia file in the compressed form. One embodiment utilizes the GSM compression because it is common to both Windows and Macintosh based computing platforms.

When the compression algorithm is used, an embodiment saves both the uncompressed multimedia file and the compressed multimedia file as separate files (step 122) and the system transmits the compressed multimedia file. However, because some recipients may not have the proper decompression software, the system can provide a link to the uncompressed multimedia file (step 124). The recipient can then access the uncompressed multimedia file. Thus, a user is guaranteed that all recipients can access the message. Further embodiments can provide only a pointer and not a direct link for security purposes. The pointer can look to, for example, a table and determine the location of the multimedia file from the table.

Either or both the compressed or uncompressed multimedia files can be saved locally by the user and recipient or by the system. The system can delete the messages after a specified amount of time, or the system can offer data storage services for a fee.

A further embodiment, illustrated in FIG. 3, includes converting the multimedia file to a text file (step 126), and transmitting the text file to the recipient address (step 128). The system can provide speech to text conversion where the multimedia file is electronically transcribed and the text of the message is sent to the recipient. This provides either the user or the recipient the ability to have a hard copy of the message for a paper file.

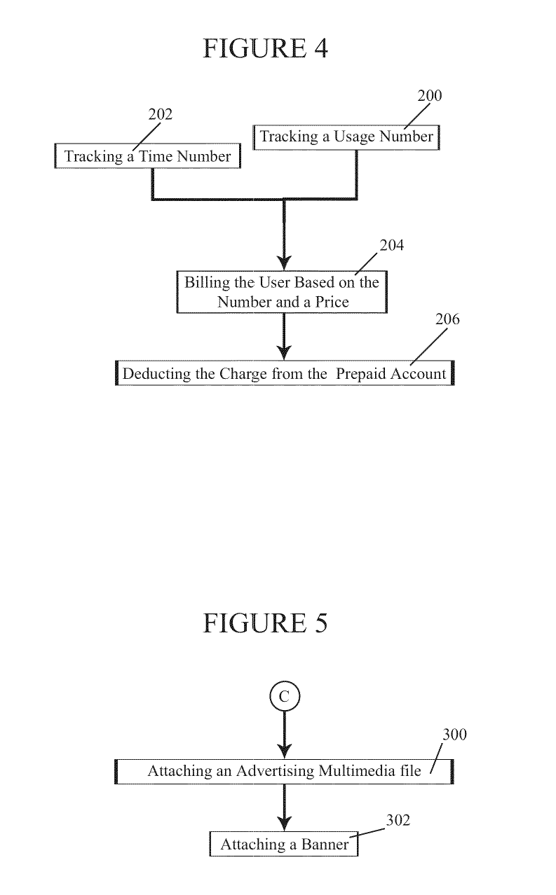

FIG. 4 illustrates numerous embodiments for billing the user for the service. One billing method includes tracking a usage number based on a number of times the user records a message (step 200) and another includes tracking a time number based on a length of time of each recorded message (step 202). Once either the usage or time number is determined, the user is charged based on the number times a price (step 204). A fixed price can be used, for example, $1.00 per message or $0.25 per recorded minute. Alternately, volume discounts can be offered, for example, $1.00 for the first 5 messages and $0.50 for all additional messages. Either tracking method can be used depending on the system or user's choice. Additionally, the user can prepay for the service at the beginning of the billing cycle and the system can include deducting the charge from the prepaid account (step 206). Further, the system can charge a flat monthly fee instead of or in addition to the above mentioned fee. One embodiment of the monthly fee is a somewhat large one time fee for unlimited use. Another embodiment is a small fee in addition to tracked options to provide a minimum amount to complete electronic transactions with, for example, banks and credit card companies.

FIG. 5 illustrates another embodiment where advertising can be used either to increase revenues or to permit the user to access the system free of charge. The method includes attaching an advertising multimedia file to a beginning of the multimedia file prior to transmitting the file (step 300). This embodiment provides that the user records his or her message and a multimedia file is created. Previous to the user's message, an advertising multimedia file is created and this can be akin to a radio or a television commercial. The advertising multimedia file is then appended to the beginning of the message multimedia file so the recipient is compelled to listen to the advertising portion prior to listening to the message.

Further, for the e-mail transmission embodiments, the method can include an advertising banner in the e-mail (step 302). Either the advertising multimedia file or the advertising banner can also be interactive and provide links to the advertisers, for example, via hyperlink, e-mail and telephone. Thus, an interested user can request more information regarding the advertised product. Furthermore, for the telephone transmission embodiments, prompts can be provided to allow the recipient to choose the product or information from the list of menu options.

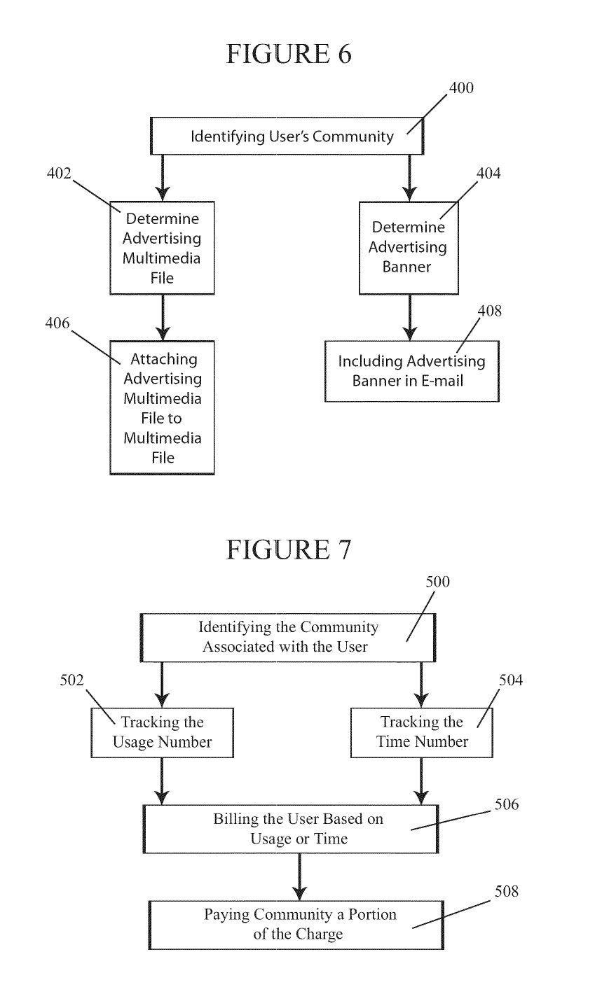

FIG. 6 illustrates a method where the user is a member of a community, typically an on-line community or logs into the system through a specifically themed website hosting the system. Once the user's information is received, the system can identify the community associated with the user (step 400). Once the user's community is identified, the system determines one or both of the advertising multimedia file associated with the community (step 402) and the advertising banner associated with the community (step 404). Once the advertising is determined, either the associated advertising multimedia file is attached to the multimedia file (step 406), or the associated advertising banner is included in the e-mail to the recipient (step 408). This embodiment allows advertisers to target users and recipients with particular interests. For example, MTV.com can host the system and a user can access the system through MTV.com. The system identifies that the user is associated with MTV.com and searches for music related advertising. Once the appropriate advertising is found, the multimedia file or banner is provided to the recipient as above.

FIG. 7 illustrates an embodiment for billing and crediting a community when a user is a member of the community. The method includes identifying the community associated with the user (step 500) and tracking at least one of the usage number (step 502) and/or the time number (step 504). The user is then billed a charge based on one of the usage number or the time number multiplied by the corresponding price (step 506). Typically, if the user is accessing the system through a community, the community is entitled to a portion of the charge and the community is paid a portion of the charge (step 508).

Another embodiment of the invention allows the user to access the system through a voice menu system. First, the user can configure an account by providing one or more of, billing information, contact information, and one or more recipient addresses. The account can be configured so that recipients can be grouped and placed under a number, for example, all family contacts can be number “1”. Once the account is configured, the user can be provided with a system access telephone number. The user can call in and identify a recipient address, i.e. number 1 in a menu system to select family contacts, record a message and the invention can operate as above. This allows a user to send an e-mail by using any telephone and does not require an Internet or network connection.

Further embodiments permit the user's entire contact list to be accessed through the voice menu system and using speech recognition to determine a recipient. For example, a user can be prompted, while configuring the account, to provide audio tags for a specific number of contacts. For example, the address of the user's wife can be stored with the audio tag “wife”. Then, when the user calls in, he can say “wife” to select the recipient as the wife's address, the user records the message and embodiment functions as above. Other voice menu prompts can be associated with other recipients or groups of recipients.

Another embodiment is a method where the system contacts the user by opening a multimedia recording session on the user's computer. Either the system can identify the computer's hardware and software capabilities or that information can be provided by the user. For example, the computer can be equipped with a microphone and web camera. Once the system contacts the user the system can open a multimedia session and the user can record the message at his computer. The multimedia recording session can be initiated on the user's own computer, the user can be directed to another web page, or the system can send the user an e-mail with a link to the recording page. Once the message is recorded, the inventor can function as described above.

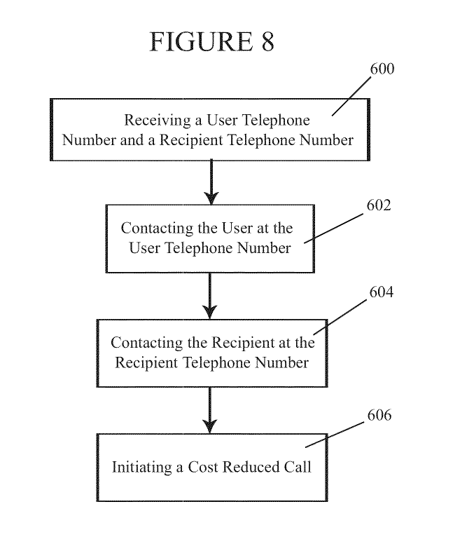

Referring to FIG. 8 and a method of communicating between a user and a recipient is illustrated. The method includes receiving, from the user, a user telephone number and a recipient telephone number (step 600). As above, the user and recipient telephone numbers can be received though at least one of a short message service message (SMS message), an e-mail message, an Internet form or an HTTP protocol message. In one embodiment, the user inputs and transmits the information via telephone. The system then contacts the user at the user telephone number (step 602) and contacts the recipient at the recipient telephone number (step 604). In one embodiment, the system can identify the user telephone number via, for example, caller id, and the user is only required to input the recipient telephone number.

In an embodiment, the system uses a least cost routing method that combines traditional land line and voice over IP technology to connect the user with the recipient (step 606). Additionally, a user can initiate a voice over IP telephone connection and does not have to have the equipment or knowledge to have a voice over IP system. Instead, it allows any two telephones to be used a voice over IP telephones and provide the user cost saving methods. This is particularly important for cellular telephone users because the user is only receiving a local call and roaming charges will not apply.

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature.

1. A method of transmitting a multimedia file over a network, comprising the steps of:
receiving, from a user, a user contact and a recipient address;
contacting the user at the user contact;
recording a message from the user as a multimedia file; and
transmitting the multimedia file to the recipient address.

2. The method of claim 1, wherein the user contact and the recipient address are received though at least one of a short message service message, an e-mail message, an Internet form and an HTTP protocol message.

3. The method of claim 1, wherein the contacting step further comprises the step of providing a menu to the user.

4. The method of claim 1, further comprising the step of compressing the multimedia file prior to the transmitting step.

5. The method of claim 4, further comprising the steps of:
saving both the uncompressed multimedia file and the compressed multimedia file as separate files and wherein the transmitting step transmits the compressed multimedia file.

6. The method of claim 5, further comprising the step of providing a link to the uncompressed multimedia file.

7. (canceled)

8. The method of claim 1, wherein the transmitting step comprises at least one of the steps of:
sending an e-mail to the recipient address attaching the multimedia file;
sending an e-mail to the recipient address providing a link to download the multimedia file;
sending an e-mail to the recipient address providing a link to stream the multimedia file;
sending an e-mail to the recipient address providing a callback telephone number to play the multimedia file over a telephone; and
sending the multimedia file to a cellular telephone as a message.

9. The method of claim 1, further comprising the steps of:
converting the multimedia file to a text file; and
transmitting the text file to the recipient address.

10. The method of claim 1, further comprising the steps of:
tracking a usage number based on a number of times the user records a message; and
billing the user a charge based on the usage number and a price.

11. The method of claim 10, further comprising the step of deducting the charge from a prepaid account.

12. The method of claim 1, further comprising the steps of:
tracking a time number based on a length of time of the recorded message; and
billing the user a charge based on the time number and a price.

13. The method of claim 12, further comprising the step of deducting the charge from a prepaid account.

14. The method of claim 1, further comprising the step of attaching an advertising multimedia file to a beginning of the multimedia file prior to the transmitting step.

15. The method of claim 1, wherein the user is a member of a community and further comprising the steps of:
identifying the community associated with the user;
determining an advertising multimedia file associated with the community; and
attaching the associated advertising multimedia file to a beginning of the multimedia file prior to the transmitting step.

16. The method of claim 1, wherein the user is a member of a community and further comprising the steps of:
identifying the community associated with the user;
tracking at least one of a usage number based on a number of times the user records a message and a time number based on a length of time of the recorded message;
billing the user a charge based on at least one of the usage number and the time number and a price; and
crediting the community a portion of the charge.

17-20. (canceled)

21. The method of claim 1, wherein the user contact is a telephone number.

22. A method of communicating between a user and a recipient, comprising the steps of:
receiving, from the user, a user telephone number and a recipient telephone number;
contacting the user at the user telephone number; and
contacting the recipient at the recipient telephone number comprising the step of initiating a connection between the user and the recipient using at least one of a traditional telephone connection and a voice over IP connection, whereby the user receives a cost savings.

23. The method of claim 22, wherein the user telephone number and the recipient telephone number are received though at least one of a short message service message, an e-mail message, an Internet form, an HTTP protocol message, and a telephone call.
